(19) United States
(12) Patent Application Publication
(10) Pub. No.: US 2015/0377379 A1
(43) Pub. Date: Dec. 31, 2015

(54) Planar valves

(71) Applicant: Yuriy Y. Krasnov, JR., Richmond Hts., OH (US)

(72) Inventor: Yuriy Y. Krasnov, JR., Richmond Hts., OH (US)

(21) Appl. No.: 14/120,765

(22) Filed: Jun. 26, 2014

(51) Int. Cl. F16K 31/06; F16K 5/04

(52) U.S. Cl. CPC F16K 31/0679; F16K 5/04

(57) ABSTRACT

A planar valve of flow of fluid in channel that is driven by a direct current and allows easy miniaturization down to millimeter scale.

### BACKGROUND OF THE INVENTION

1. Field of the Invention

The present invention relates generally to systems of transportation of fluids, Particularly, the present invention relates to the design of valves of streams of fluid: for closing and/or opening a channel, for switching flow of fluid from one channel to another one, for allowing fluid to flow in two directions, etc.

2. Description of the Related Art

The last decade of development of the integrated circuits, especially CPUs (central processing units) and GPUs (graphic processing units), evidently demonstrated that we have reached the limits of frequencies, at which the traditional air cooling of working processors can provide reliable evacuation of the generated parasitic heat in order to keep said processors within the safe domain of their temperatures. It became clear that future progress in the increasing of working frequencies of processors is possible only with implementation of the convective cooling of processors by the circulating fluid coolant, particularly water. The water cooling of servers already became a routine practice in the big Data Centers. Individual enthusiasts are using self-made convective water cooling systems in their PCs, reaching frequencies 2-3 times higher, than CPUs and GPUs manufacturers' recommended values. Industry offers some convective cooling systems for Desktops, but all of them are essentially oversized, overweight, expensive and inefficient. There are no solutions for Laptops on the current Market.

All implemented solutions for water cooling of the integrated circuits actually are employing well known and very traditional methods and systems of the domestic plumbing and heating and cooling, while the cooling of PC is much more complex problem and it requires much more sophisticated and flexible approach.

Particularly, an efficient multi-modular cooling system requires implementation of certain valves of streams of a fluid coolant in order to provide optimal cooling in different regimes of operation of the chilled elements. Limited dimensions of laptops essentially restrict the implementation of valves that are currently offered on the market: the invention of new designs of valves is highly demanded.

There is a huge variety of valves of fluid streams on the contemporary market with the same functionality and many different manners of operation: manual, pneumatic, by electric motors, etc., but none of them can satisfy the most important requirement that is crucial for the implementation in laptops: to have overall thickness of about several millimeters, be driven by electricity, and have price within the range of a few dollars.

### SUMMARY OF THE INVENTION

It is an object of the present invention to teach the method and a system of switching flows of a fluid in channels and between channels, wherein designed valves
Can be miniaturized up to thickness of a few millimeters;
Can be manipulated by the electric current;
Can provide reliably switched for hundreds of thousands of times.

### BRIEF DESCRIPTION OF THE DRAWINGS

Advantages and features of the present invention are better understood with the reference to the following more detailed description and claims taken in conjunction with accompanying drawings, in which like elements are identified with like symbols.

FIG. 1 shows the schematics of invented planar valves.

FIG. 2 shows a drawing of the universal base for all types of invented planar valves.

FIG. 3 shows a drawing of the piston for valve that opens and closes flow in a straight channel, i.e. it “a straight valve”.

FIG. 4 shows a drawing of the piston for valve that opens and closes flow between two channels that are directed by normal in respect to each other, i.e. is “a corner valve”.

FIG. 5 shows a drawing of the piston for valve that is switching a flow from one channel in either the second one or the third one, i.e. is “a T-valve”.

FIG. 6 shows a drawing of the rotor for a straight valve.

FIG. 7 shows a drawing of the rotor for the corner valve and T-valve.

FIG. 8 shows the schematics of how the straight valve works.

FIG. 9 shows the schematics of how the T-valve works.

FIG. 10 shows the schematics of the dual-valve.

### DESCRIPTION OF THE PREFERRED EMBODIMENTS

The best mode for carrying out the invention is presented in terms of its preferred embodiment, herein depicted within the Figures.

### 1. Detailed Description

A preferred embodiment's of the planar valve and its main functionality is to provide a reliable switching of the stream of fluid between different channels by switching the polarity of the electric current on its driver.

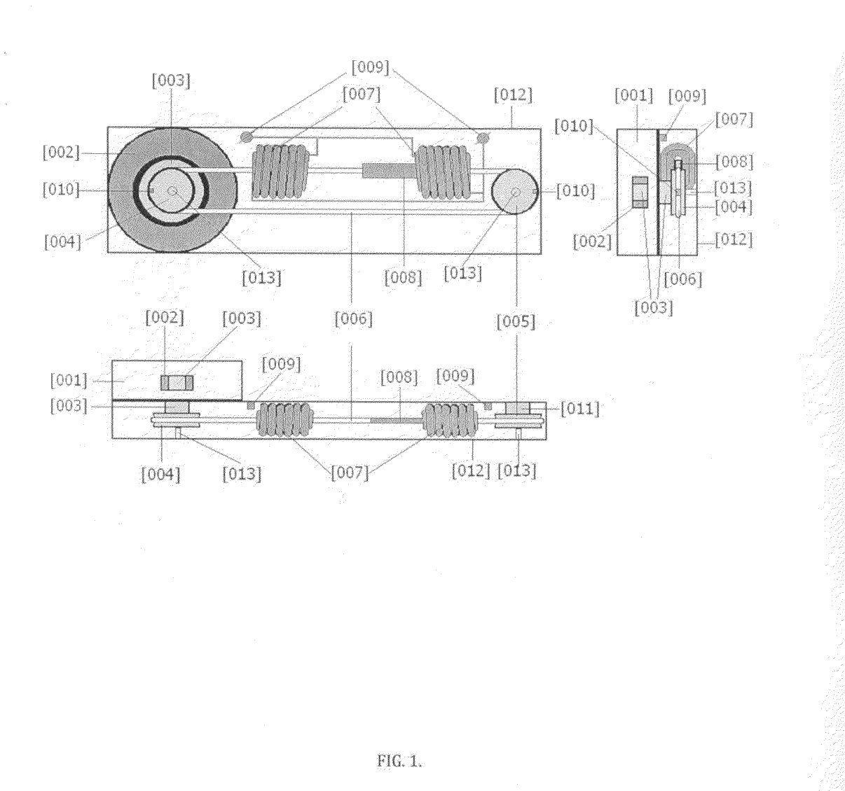

FIG. 1 illustrates the schematics of invented valves. All valves comprising the same base [001] and the same driver box [012].

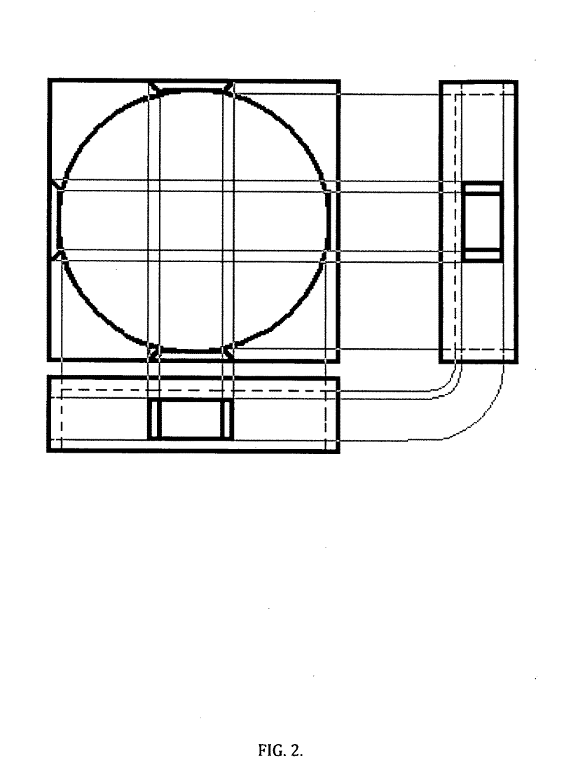

The drawing of the base [001] is shown in FIG. 2: it is a rectangular topless box with cylindrical hole inside and with holes in the three sides of its wall that allow for an attachment of external channels to said sides.

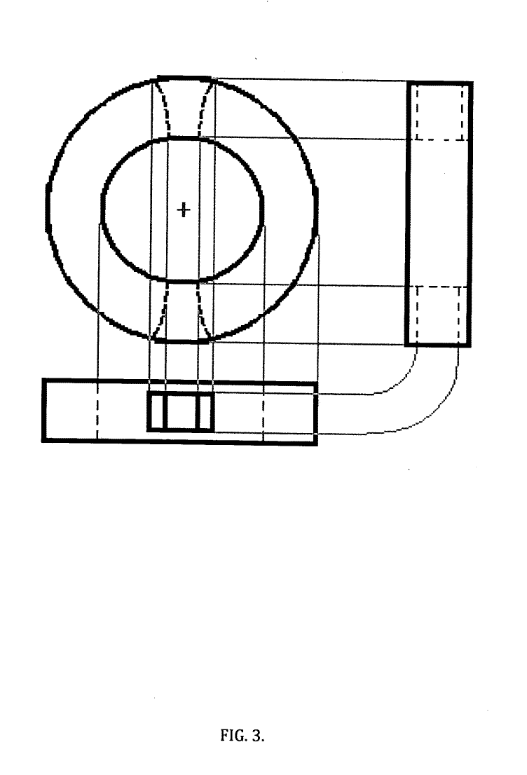

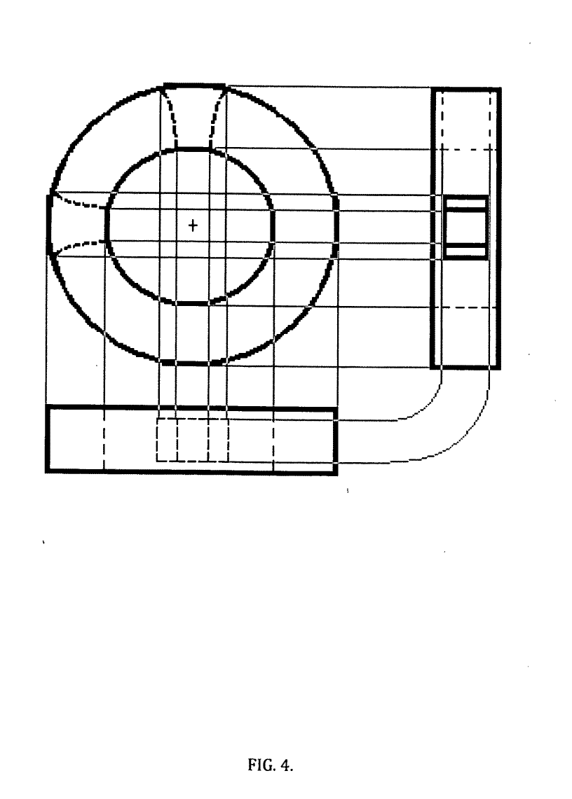

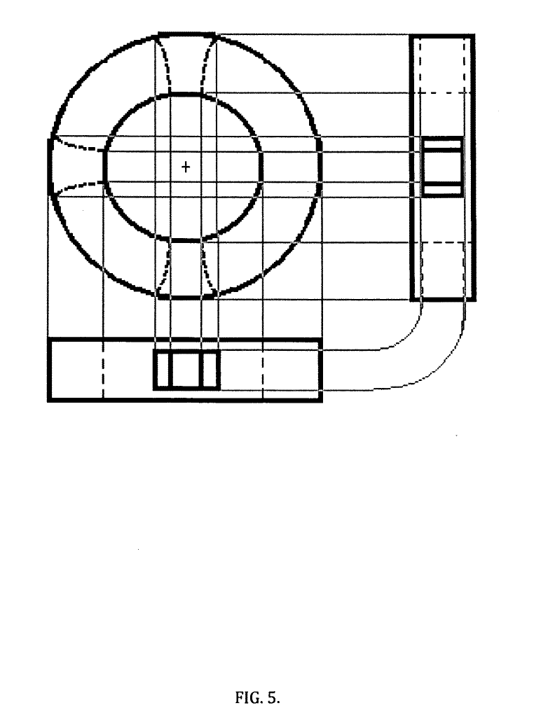

A variety of valves can be created by placing inside said base different pistons [002] with appropriate cores [003]. FIG. 3 shows the drawing of a piston for a straight valve; FIG. 4 shows the drawing of a piston for a corner valve; FIG. 5 shows the drawing of a piston for a T-valve. All pistons are made in shape of a rectangular ring and differ only by numbers and positions of holes in their bodies: the piston for a straight valve has two holes opposing each other, the piston for a corner valve has two holes under 90 degrees to each other, and the piston for a T-valve has three holes under 90 degrees of one hole to the next one, just as it is shown in FIGS. 3, 4 and 5. All pistons are meant to be placed inside the base [001] and be reliably attached there in order to restrict any motions of said pistons.

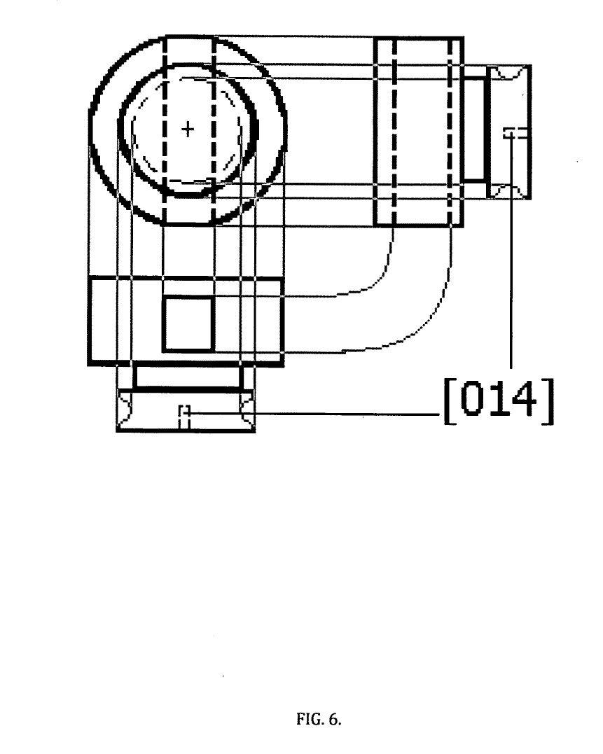

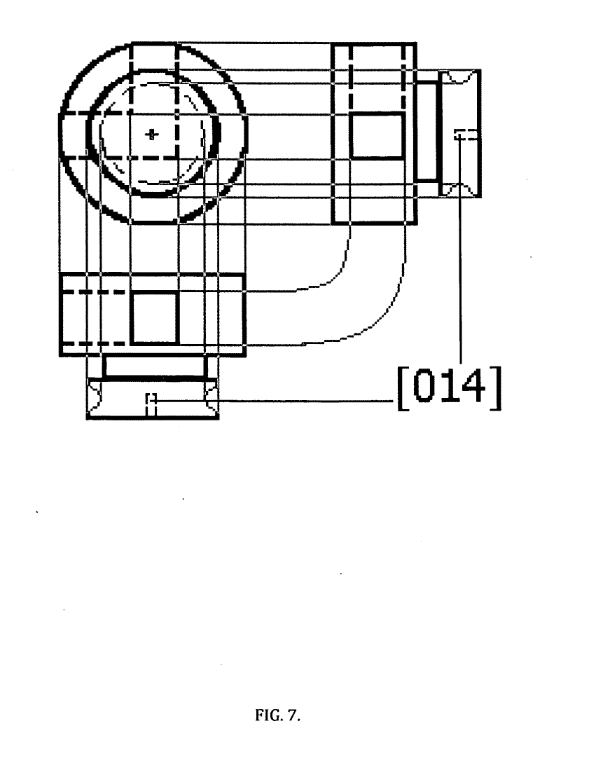

The drawing of the core for straight valve is shown in FIG. 6, and the drawing of the core for the corner valve and T-valve is shown in FIG. 7. Each core has a shape of a cylinder and the top of this cylinder is formed in the shape of a turning disk [004] with a hole [014] (see FIG. 6 and FIG. 7) for a proper semi-axel [013]. The core [003], being placed in a piston, can freely rotate around its axis of symmetry. The height of core is bigger, than height of piston, so that, turning disk [004] stays over the top surface of the base with the piston in it.

The entire set—the base with the piston and core inside it—is placed on the top of the driver box [012] on the one end of said box. On the other end of the driver box [012] the matching turning disk [005] is attached on the proper pedestal [011]. The rod loop [006] is put on both turning disks [004] and [005]. This rod loop is attached to both turning disks in points [010] that are marking the maximal distance between said disks. Such setting provides a signature feature of this pare of turning disks: when one disk turns 90 degrees, the second one also turns 90 degrees in the same directions even if there is no friction between rod and disks.

The one half of said rod loop goes through two complementary coils [007] and has an attached permanent magnet [008]. Complementariness of coils means that, being fed from the same source of a direct electric current, which is delivered by en external source through electrodes [009], they produce magnetic fields that are in opposite directions to each other.

In just said conditions, permanent magnet [008] has only two points of equilibrium between said coils: near by each of coils; at one polarity of voltage on electrodes [009] the equilibrium of permanent magnet [008] is near by the right coil, and at opposite polarity—near by the left coil; consequently, at switching of polarity of the direct voltage on electrodes [009], permanent magnet [008] will be repulsed from its position near by one coil to the position near by complementary coil, and otherwise. The distance between turning disks [004] and [005], their radiuses, and the length of permanent magnet [008] should be chosen in such manner to provide the following signature condition of the present invention: relocation of permanent magnet [008] from of one its equilibrium position near by one coil to its other equilibrium position near by the complementary coil should cause the turning disks [004] and [005] turn exactly on 90 degrees in the same direction.

### 2. Operation of the Preferred Embodiment

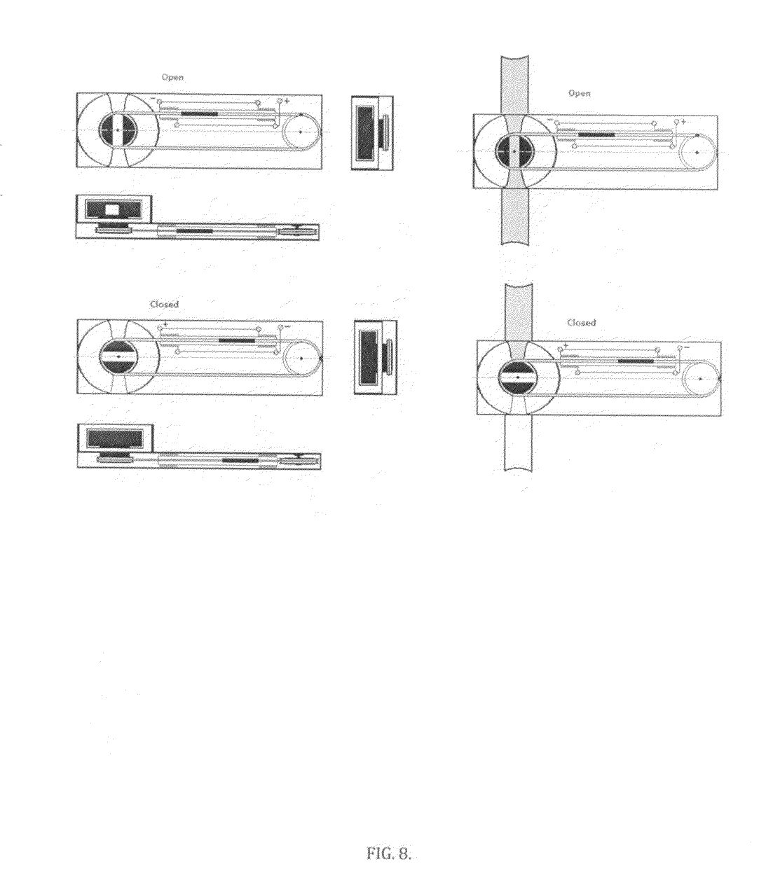

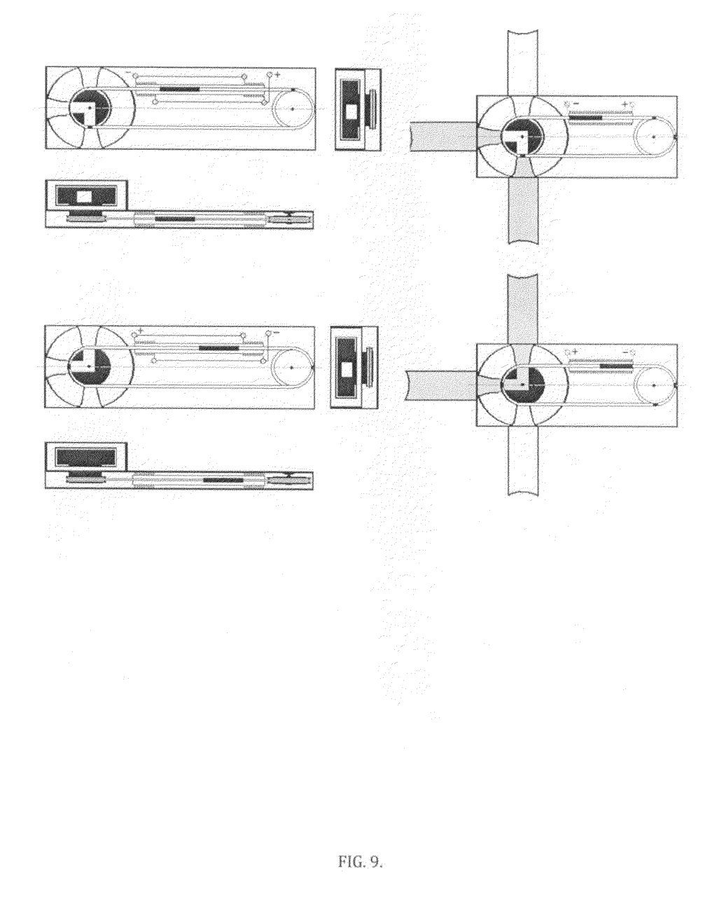

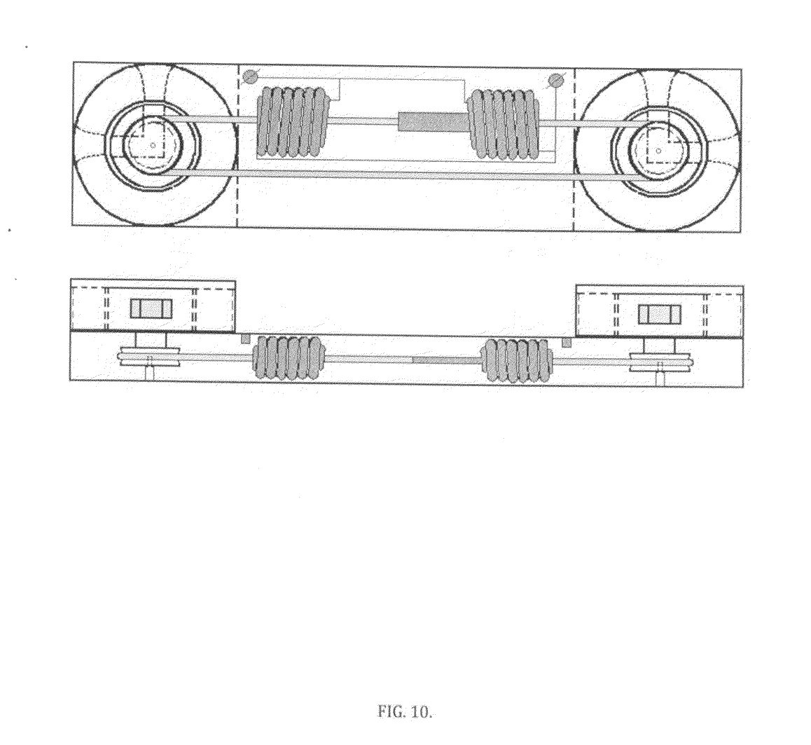

It is anticipated that all disclosed features are provided due to the all properly designed disclosed parts of the present invention. Then the regulated channels should be reliably attached to the holes in the sides of base of the used valve (manners of such attachments are not subjects of the present invention). The operations of such arranged implementations are illustrated schematically in FIG. 8—for a straight planar valve, in FIG. 9—for the planar T-valve, and in FIG. 10—for a dual-valve. As one can see, the switching of streams of a fluid between regulated external channels that are attached to holes in the base of used valve goes by a simple application of a working direct voltage of a given polarity to electrodes [009] of the used valve.

3. The foregoing descriptions of specific embodiments of the present invention are made for purposes of illustration and description. They are not intended to be exhaustive or to limit the invention to precise forms disclosed and, obviously, many modifications and variations are possible in light of the aforementioned teaching. The embodiments are chosen and described in order to best explain principles of the invention and its practical application, to thereby enable others skilled in the art to best utilize the invention and its various embodiments with various modifications as are suited to the particular use contemplated. It is intended that the scope of the invention be defined broadly by the Drawings and Specification appended hereto and to their equivalents. Therefore, the scope of the invention is in no way to be limited only by the following exemplary claims nor by any possible, adverse inference under the rulings of Warner-Jenkins Company, v. Hilton Davis Chemical, 520 US 17 (1997) or Festo Corp. V. Shoketsu Kinzoku Kogyo Kabushiki Co., 535 U.S. 722 (2002), or other similar case law or subsequent precedent should not be made if such claims are amended subsequent to this Non-provisional (Utility) Patent Application.

Having thus described the invention what is claimed as new is as follows:

1. A planar valve comprising:
a base having a cylindrical hollow in it and at list two holes in its side wall that are connecting said inner hollow with outside environment;
a piston that fits precisely inside said cylindrical hollow of the base's cylindrical hollow, has a shape of a rectangular ring and side holes that are exactly matching the holes in side walls of the base when said piston fits in the base's cylindrical hollow;
a cylindrical core that fits precisely into the inner space of said piston ring and can be freely rotated there around its axis of symmetry; has a channel inside, ends of which can connect two side holes in said piston when said cylindrical core is fitted into the inner space of said piston ring and is turned on some proper angle around its axis of symmetry; and top of said cylindrical core has a shape of a turning disk;
a rectangular driver box, to the bottom of which the base with piston and cylindrical core inside can be attached from outside of said box on the one of its end, and having the reciprocal turning disk on the other end of its bottom;
two wire coils that ate attached to said driver box inside on a specific distance (defined bellow) from each other and are connected to voltage entrance electrodes in such manner that said coils, being fed by a direct current, generate magnetic field with opposite directions to each other;
a non-stretchable rod loop that is set on both turning disks—the made on the top of said cylindrical disk and on the reciprocal turning disk that is attached to the bottom of said driver box on the other end of it; and said rod in said loop has one of its part penetrating through both said coils and has a strip of a permanent magnet fixed on it in the specific place (defined bellow) between said two coils;
wherein:
said rod loop should be reliably attached to said turning disk in one point of each of them at maximal possible distance from each other (i.e. in the opposite ends of their co-linear diameters) with condition that the inner channel in said cylindrical core precisely connects two holes in the piston and the magnet strip is exactly in its equilibrium point near by one of said wire coils at some polarity of voltage on them;
the distance between turning disks, their radii and the length of said strip of a permanent magnet should be chosen in such manner that at relocation of said strip from one equilibrium position of said magnet strip near by one coil to its other equilibrium position near by the complementary coil should cause turn of cylindrical core inside said piston on such angle around its axis of symmetry which surely provides a reliable disconnection of the outer channels due to a proper turn of said inner channel inside said cylindrical core.

2. The apparatus of claim 1, further using a turning disks of the cylindrical core of the second base with piston and a cylindrical core inside that is attached to said driver box instead of a reciprocal turning disks that is claimed in claim 1, wherein it creates a planar double-valve that can manage a simultaneous regulation of flow in two independent systems of external channels.
